(19) United States
(12) Patent Application Publication
(10) Pub. No.: US 2007/0174156 A1
(43) Pub. Date: Jul. 26, 2007

(54) Representations of cash locations

(76) Inventors: Martin von der Emde, Wiesloch (DE); Thomas Hoffmann, Romerberg (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/323,955

(22) Filed: Dec. 30, 2005

(51) Int. Cl. G07F 19/00; G07B 17/00

(52) U.S. Cl. 705/30

(57) ABSTRACT

A cash management system includes a cash location business object, an owner business object associated with the cash location business object, and a provider business object associated with the cash location business object. The cash location business object further includes a plurality of attributes including a type of cash.

### BACKGROUND

Cash management is very important to any business entity. In fact, some say that cash management is the lifeblood of any business. If the cash of a business entity is well managed, the business entity has a much better chance of thriving. If cash of a business is managed poorly, the business is much more likely to face crisis due to shortages of cash, or insufficient cash flow.

Cash management includes assuring that sufficient cash is in a business to assure the daily operation of the business entity. Cash management includes maximizing cash flow into the business entity by making certain that billing, collections, and payables systems are operating as efficiently as possible. For example, maximizing cash flow includes billing promptly, aggressively following up on overdue invoices, and, if possible, requiring up-front deposits. The business entity also manages the outflow of cash by holding onto cash as long as possible by managing the business entities payables.

Cash management also includes determining the amount of cash of various types that are in various accounts owned by a business on a periodic basis. Cash management also includes moving cash between accounts to maximize cash flow and prevent penalties for violating rules associated with various accounts. Cash management also includes forecasting to determine if there will be a shortage of cash or upcoming problems with cash flow. If a cash flow or shortage is forecasted, the business can proactively make arrangements to provide cash at the best possible rates. In the event there is excess cash available, the excess cash is placed in accounts that have sufficient liquidity to provide cash in case of an emergency. In some businesses, the amount of cash is determined on a daily basis or even multiple times during the day. In still other business entities, the amount of cash in the business entity is constantly monitored.

Some business entities monitor and control cash using a software system for both operational purposes as well as for accounting purposes. When additional types of accounts or a new payment medium is added, the software system must be modified. In addition, the cash management systems must also be modified.

### BRIEF DESCRIPTION OF THE DRAWINGS

FIG. 1 is a block diagram of a computing environment, according to an example embodiment.

FIG. 2 is a display of a model of a business object, according to an example embodiment.

FIG. 3 is a schematic of a business entity that includes liquid cash at a plurality of locations, according to an example embodiment.

FIG. 4 is a schematic of a cash management system that includes a cash location business object related to an owner business object, a provider business object and another cash location business object, according to an example embodiment.

FIG. 5 is a flow diagram of a method of creating business object cash locations and relating the business object cash locations to other business objects, according to an example embodiment.

FIG. 6 is a flow diagram of a method of cash management, according to an example embodiment.

FIG. 7 is a flow diagram of a method of cash management, according to an example embodiment.

FIG. 8 is a block diagram of a computer system that executes programming, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

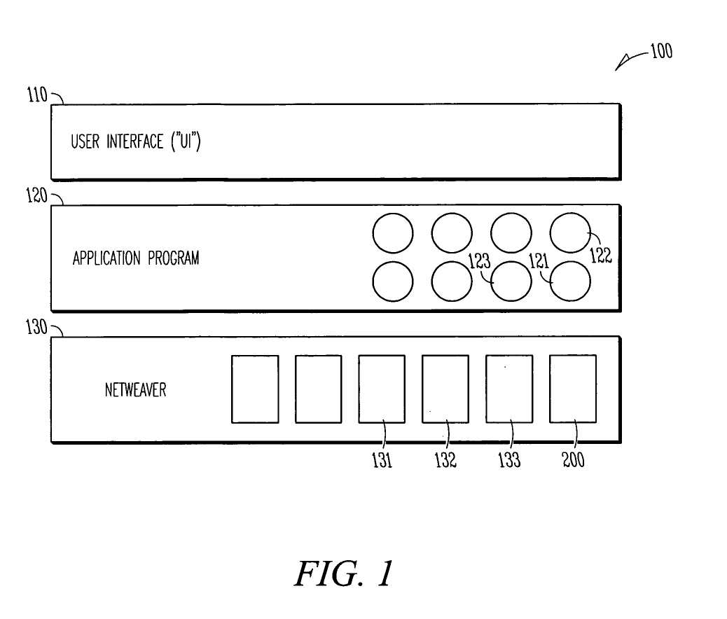

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200, which includes various integration tools for performing business analysis on business information within the computing environment 100. The application program layer 120 also includes a number of distributed objects 121, 122, 123. The object is a technical representation of a concept that includes data and logic. In one example embodiment, the object, such as object 131, 132, 133 is referred to as a business object and is a technical representation of a business concept that includes data and logic.

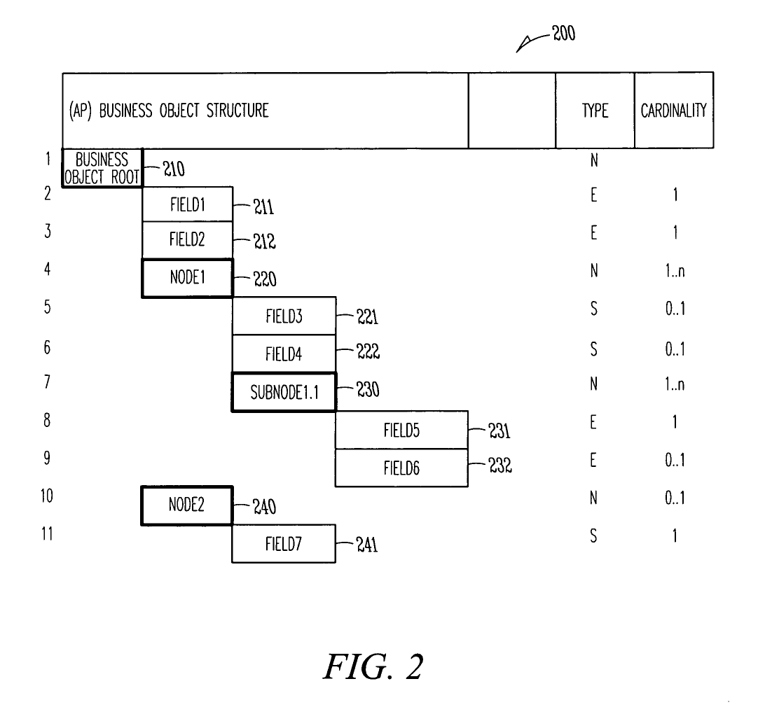

FIG. 2 is a display of a model 200 of a business object, such as business object 121, according to an example embodiment. A business object or object has a structure that includes a root 210, nodes such as nodes 220 and 240, and a sub node 230. Associated with a business or a root 210 is a grouping of information related to the business object root or root 210. Some of the information is held in fields such as 211 and 212. The information is also held in a node 220 which in turn also represents a grouping of information such as data and logic which are held in fields 221 and 222. Also under the root 210 and node 220 is a sub node 230. Sub node 230 holds another grouping of information that includes data and logic that are held in fields 231, 232. The business object 200 also includes another node 240. Node 240 is at the same level as node 220 and includes another grouping of data and logic which includes field 241. Therefore, it is seen that object 200 or business object 200 has a structure which includes a root 210, nodes, such as nodes 230 and 240, and sub nodes, such as sub node 230. It should be noted that FIG. 2 shows a simplified example of the structure of an object or business object 200. In actuality, a business object or object 200 may have a more complex structure. However, the principles as set forth in FIG. 2 will be followed where each root, node and/or sub node includes a grouping of information that can include data and logic.

In some embodiments, the structure of the business object or an outline of the business object is used to form a model of the business object 200. A model is useful for the purposes of designing and programming in a business object, such as business object 200. A model of the business object 200 shows the structure. In some embodiments, the model is referred to as a template. A template or model can take on any form just so it shows the structure of the object or business object 200. As shown in FIG. 2, the template is formed on a spreadsheet, such as an Excel spreadsheet. Excel is a registered trademark of Microsoft Corporation.

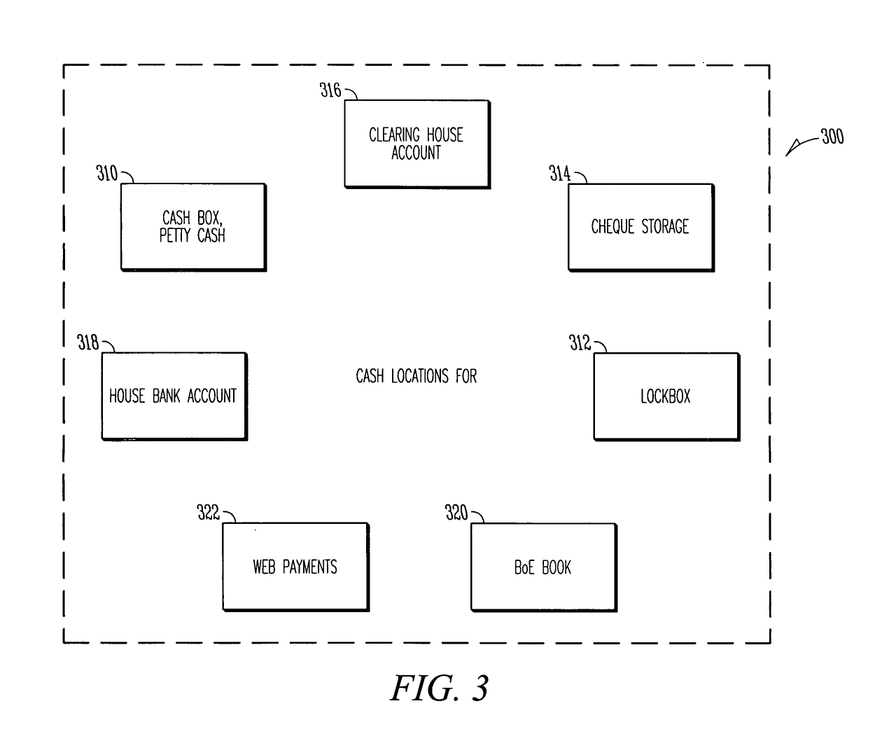

FIG. 3 is a schematic of a business entity 300 that includes liquid cash at a plurality of locations, according to an example embodiment. The business entity 300 generally has cash that needs to be managed in a variety of different types of accounts or other cash locations. For example, the business entity 300 may have cash in a cash box 310, a lock box 312, a check storage area 314, a clearinghouse account 316, a house bank account 318, a bill of exchange account 320, and a web payments account 322. These sources of liquid cash may be totally within the control of the business owner 300 or business entity 300 as is the case with a cash box 310 and a check storage are 314. Other sources of liquid cash may be controlled by others such as the web payment account 322, various lock boxes 312, a clearinghouse 316, and a house bank account 318. The accounts not totally in control of the business entity 300 are in control of others.

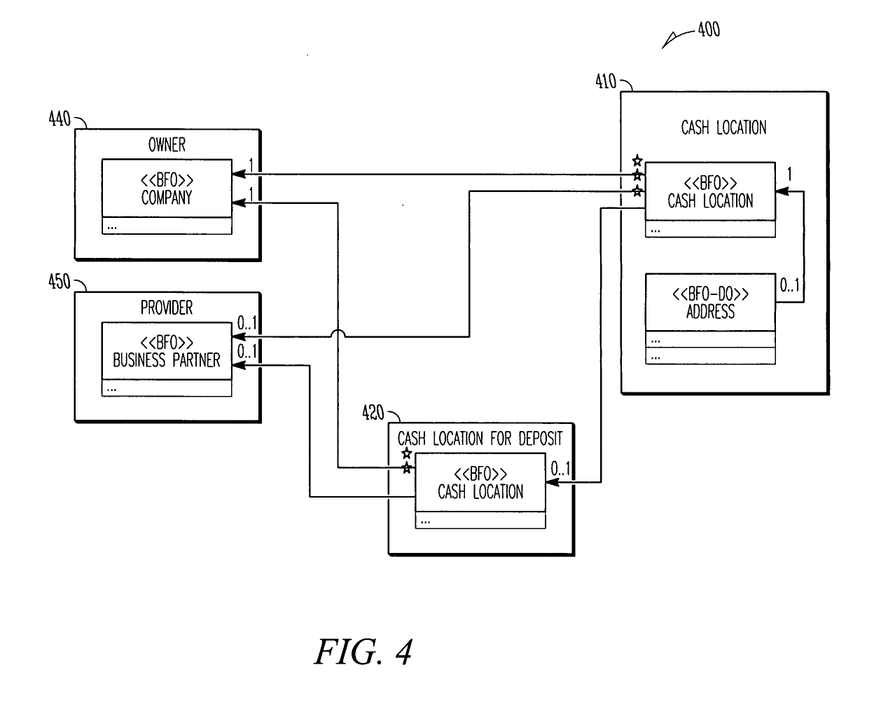

FIG. 4 is a schematic of a cash management or payment system 400 that includes a cash location business object 410 related to an owner business object 440 and a provider business object 450. The cash location 410 is a source of cash that has various attributes that are set forth or defined by the cash location business object. One of the attributes or properties of a cash location business object 410 is the type of cash location. For example, the type of cash location may be a cash box for petty cash or an account or virtual payments or a house bank account. One of the attributes defines the type of cash location associated with the cash location business object. The cash location business object also includes an internal identification which is a number specific to that particular business object. Thus, the internal identification number identifies the specific cash location business object 410 with respect to all other business objects associated with the computing environment 100 (see FIG. 1).

Another attribute or property of the cash location is an external identification number. A common external identification number is an account number for a house account or bank account, or a virtual payment. The external identifier identifies this particular account to a provider of the account. Still another attribute or property is the physical location of the cash location business object. For example, a cash box may be located in a specific room in a specific building on the owner's premises. Also, a house bank account may be located at a branch of a bank remote from the business entity. Lock boxes may be located in different countries. Lock boxes typically are secured containers where customers pay by check or otherwise. For each lock box held, there will be a physical location. Other attributes include allowed currencies. Some cash locations require payment in one or two currencies while others only allow payment in one currency. Lock boxes and checks typically can be paid in a number of currencies or a plurality of currencies.

Still another attribute is the operational currency which is displayed by the particular cash location business object 410. Some cash location business objects also have upper and lower limits that must be either met or not be exceeded before a certain action takes place. For example, at an upper limit a cash location business object, once an upper limit is exceeded cash will be removed from that particular business object and transferred to another business object. Similarly, other cash location business objects have lower limits and when the amount of cash associated with the cash location business object 410 is less than the lower limit, there may be a penalty that is incurred. For example, in some house bank accounts or checking accounts if the limit drops below a certain threshold, a higher level of interest or a higher level of fees may be incurred when using an account. Still other attributes include default locations for transfers of cash into or out of a particular cash location business object. There also may be other rules associated with a particular cash location business object include blocks and reasons for blocking certain transactions as well as a status check that may include various approval statuses associated with a cash location. All of these various properties or attributes can be associated with a cash location business object. Some of these attributes will be helpful or instrumental in managing cash flow into and out of various cash location business objects associated with an entity.

The cash location business object also implements various processes. In some instances, the various processes may be referred to as subsystems associated with a cash location business entity 410. Some common processes or subsystems relate to creating the account, changing the account, retrieving transactions, blocking the account, closing the account, deleting or archiving various transactions queries that can be placed or made regarding information and processes associated with the cash location business object. Other processes include approval for various transactions and day of closing or cash inventory procedures that are useful in determining an amount of cash associated with a cash location business entity 410 and which report to the business entity or owner.

Associated with the cash location business object is an owner business object 440. The owner business object is related to the cash location business object. The cash location business object is related to the owner business object for several reasons. One of those reasons is that the cash location business object will have an owner but is defined by the relationship of the cash location business object 410 to the owner business object 440. Given that there are generally plurality of cash location business objects by merely relating that to an owner business object, the owner business object can be updated very easily. For example, if owner information should change, every account or every cash location business object does not have to be updated to include a new address. The owner business object merely has to be updated to reflect the new information. Similarly associated with each cash location business object is a provider business object 450. The provider, in some instances, will be the owner of the business entity. In other instances, an outside provider will be designated by the relationship between the cash location business object 410 and the provider business object 450. The cash location business object 410 also may be related to other cash location business objects, such as cash location business object 420. The cash location business object 420 is for deposits or transfers of money into the cash location business object 410.

In a cash management or payment system such as cash management system or payment 400, cash awaiting to be deposited may also be part of the cash liquidity or cash available when each of the cash location business objects is polled to determine an amount of cash associated with the particular cash location business object 410 or 420. As mentioned previously, the cash location business object 410 may designate a default for deposits which can be the cash location business object for deposit 420 shown in FIG. 4. The cash location business object for deposit includes a house bank account, cash account or other cash account. The cash location for deposit 420 includes a physical address. In addition, the cash location business object for deposit 420 is related to an owner business object 440. The cash location business object for deposit 420 is also related to a provider business object 450. In some instances, the cash location business object for deposit 420 may be provided by the business entity. In other instances, the provider associated with the provider business object 450 may be a concern outside of the business entity.

A provider business object could include a house bank, a lock box provider, a clearing house or a related company or any other business partner. The cash location business object for deposit 420 could also include a house bank account, cash account or any other cash location.

The cash management or payment system 400 includes a cash location business object 410, an owner business object 440 associated with the cash location business object 410, and a provider business object 450 associated with the cash location business object 410. The cash location business object 410 further includes a plurality of attributes including a type of cash. In some example embodiments, the owner business object 440 and the provider business object 450 name the same business entity. The cash location business object 410 can include attributes such as an address of a physical location, a default location for cash transfers, an external identifier, an internal identifier, and attributes related to currency. The cash location business object 410 of the cash management system 400 can also include subsystems or processes related to approvals, and subsystems related to determining an amount of cash associated with the cash location business object. The cash management system 400 can also include another cash location business object 420 related to the first cash location business object 410.

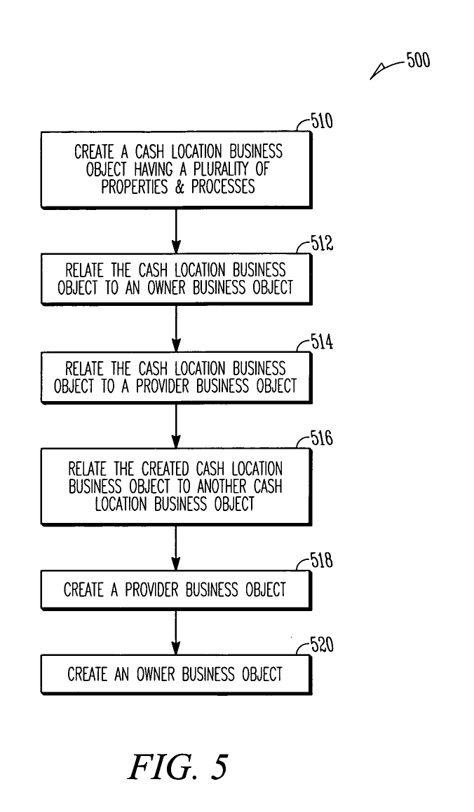

FIG. 5 is a flow diagram of a method of creating business object cash locations and relating the business object cash locations to other business objects, according to an example embodiment. The method 500 includes creating a cash location business object having a plurality of properties and processes 510. Creating the cash location business object includes designating a type of cash location. Types of cash locations include a cash box, clearing house account, check storage, lock box, bill of exchange book, virtual payments and the like.

Each cash location business object is provided with attributes or properties including an external identifier, such as a provider's account number, and an internal identifier which is unique to the cash location business object. Other attributes or properties can also be associated with the created cash location business object. The cash location business object is also provided with processes or subsystems. Some of the subsystems relate to approval for releasing or rejecting cash transactions as well as cash inventory processes such as counting cash associated with the cash location business object at day-end-closing or at the start of a day. Other processes or subsystems can also be created along with the cash location business object. Once created, the cash location business object is related to an owner business object, as depicted by reference numeral 512. The cash location business object is also related to a provider business object, as depicted by reference numeral 514. In other words, the cash location and the type of cash is put into a separate business object from an owner as well as the provider. The owner is placed in an owner business object and the provider is placed in a provider business object. Therefore, a cash location business object is created. A separate business object for an owner and another separate business object for a provider are also related to the created cash location. The point is, there is an owner business object, a provider business object and a cash location business object which are separate from each other.

In some embodiments, the newly created cash location business object is again related to another cash location business object, as depicted by reference numeral 516. One common relation of a newly created cash location business object is to a cash location business object used to transfer funds into or out of the newly created cash location business object. In still other embodiments, a provider business object is created as depicted by reference numeral 518. This typically happens when the cash location business object that has been created is provided by a new provider to the business entity. In still other embodiments, and owner business object is also created as depicted by reference numeral 520. This typically occurs when a new owner of the cash location business object has been created. This can happen when a new cash management system 400 is being assembled or when a subsidiary has been created to a present business entity and a new business owner is then created as an owner business object.

The method 500 includes creating a cash location business object having a plurality of properties and processes 510, relating the cash location business object to an owner business object 512, and relating the cash location business object to a provider business object 514. In some embodiments, the method 500 also includes relating the created cash location business object to another cash location business object 516. The method 500, in some embodiments, also includes defining processes for execution by the created cash location business object, and setting attributes for the created cash location business object. The method 500 also can include creating a provider business object 518, or creating an owner business object 520.

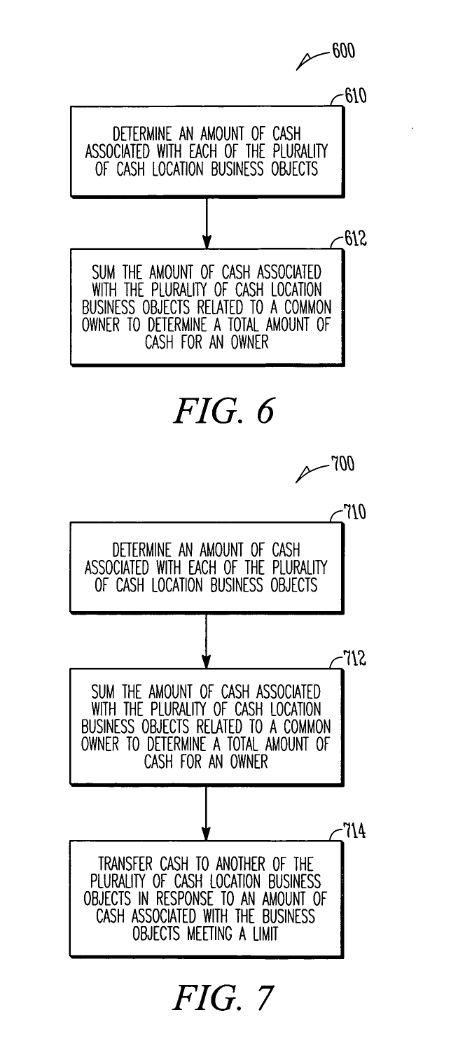

FIG. 6 is a flow diagram of a method 600 of cash management, according to an example embodiment. The method 600 of cash management includes determining an amount of cash associated with each of the plurality of cash location business objects 610, and summing the amount of cash associated with the plurality of cash location business objects related to a common owner to determine a total amount of cash for an owner 612. Summing an amount of cash associated with a plurality of cash location business objects further includes determining which of the plurality of business objects are related to an owner business object. The method 600 can be performed at a selected time. In another embodiment, determining an amount of cash associated with each of a plurality of cash location business objects 610, and summing the amount of cash associated with the plurality of cash location business objects 612 is performed substantially simultaneously.

FIG. 7 is a flow diagram of a method 700 of cash management, according to an example embodiment. The method 700 is closely related to the method 600. In fact, the first two elements 710, 712 correspond to the elements of method 600. The method 700 includes transferring cash to another of the plurality of cash location business objects in response to an amount of cash associated with the business objects meeting a limit 714.

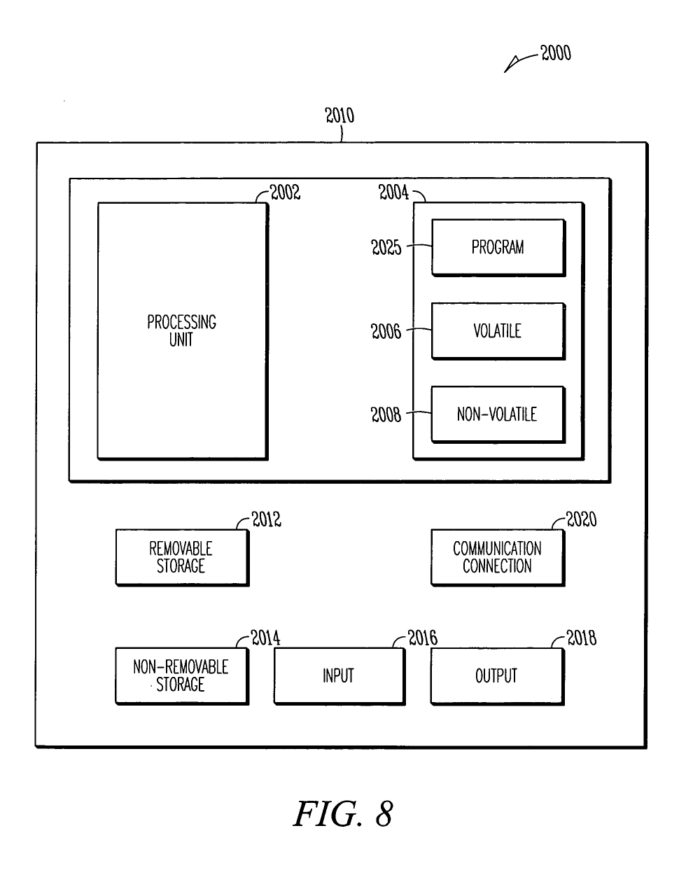

A block diagram of a computer system 2000 that executes programming for performing the algorithms discussed above is shown in FIG. 8, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A machine-readable medium includes a set of instructions that, when executed by a machine, cause the machine to perform the method of includes determining an amount of cash associated with each of the plurality of cash location business objects, and summing the amount of cash associated with the plurality of cash location business objects related to a common owner to determine a total amount of cash for an owner. The machine-readable medium includes instructions that cause a machine, such as the computer system 2000 (see FIG. 8) to execute instructions corresponding to the methods 500, 600, 700. Of course, the machine-readable medium can also cause the machine to perform other methods, including enhanced methods within the scope of this invention.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A system comprising:
a cash location business object comprising a plurality of attributes including a type of cash location;
an owner business object associated with the cash location business object; and
a provider business object associated with the cash location business object.

2. The system of claim 1 wherein the owner business object and the provider business object name the same business entity.

3. The system of claim 1 wherein the cash location business object includes as an attribute a physical address associated with the cash location business object.

4. The system of claim 1 wherein the cash location business object includes an attribute related to currency.

5. The system of claim 1 wherein the cash location business object includes an attribute related to a default location for cash transfers.

6. The system of claim 1 wherein the cash location business object includes an attribute related to an external identifier.

7. The system of claim 1 wherein the cash location business object includes an attribute related to an internal identifier.

8. The system of claim 1 wherein the cash location business object includes a subsystem related to approvals.

9. The system of claim 1 further comprising another cash location business object related to the first cash location business objects.

10. The system of claim 1 wherein the cash location business object includes a subsystem related to determining an amount of cash associated with the cash location business object.

11. A method comprising:
determining an amount of cash associated with each of the plurality of cash location business objects; and
summing the amount of cash associated with the plurality of cash location business objects related to a common business owner to determine a total amount of cash for the business owner.

12. The method of claim 11 wherein summing an amount of cash associated with a plurality of cash location business objects further includes determining which of the plurality of business objects are related to an owner business object.

13. The method of claim 12 wherein determining an amount of cash associated with each of a plurality of cash location business objects and summing the amount of cash associated with the plurality of cash location business objects are performed at a selected time.

14. The method of claim 12 wherein determining an amount of cash associated with each of a plurality of cash location business objects and summing the amount of cash associated with the plurality of cash location business objects are performed substantially simultaneously.

15. The method of claim 11 further including transferring cash to another of the plurality of cash location business objects in response to an amount of cash associated with the business objects meeting a limit.

16. A machine-readable medium including a set of instructions that when executed by a machine perform the method of claim 11.

17. A method comprising:
creating a cash location business object having a plurality of properties;
relating the cash location business object to an owner business object; and
relating the cash location business object to a provider business object.

18. The method of claim 17 further comprising relating the created cash location business object to another cash location business object.

19. The method of claim 17 further comprising defining processes for execution by the created cash location business object.

20. The method of claim 17 further comprising setting attributes for the created cash location business object.

21. The method of claim 17 further comprising creating a provider business object.

22. The method of claim 17 further comprising creating an owner business object.
